(19) United States
(12) Patent Application Publication
(10) Pub. No.: US 2014/0298383 A1
(43) Pub. Date: Oct. 2, 2014

(54) SERVER AND METHOD FOR TRANSMITTING PERSONALIZED AUGMENTED REALITY OBJECT

(71) Applicant: Intellectual Discovery Co., Ltd., Seoul (KR)

(72) Inventors: Geun Sik JO, Incheon (KR); In Ay HA, Incheon (KR)

(73) Assignee: Intellectual Discovery Co., Ltd., Seoul (KR)

(21) Appl. No.: 14/230,440

(22) Filed: Mar. 31, 2014

(30) Foreign Application Priority Data
Mar. 29, 2013 (KR) 10-2013-0034824

(51) Int. Cl. H04N 5/445; H04N 21/41; H04N 21/472; H04N 21/21; H04N 21/4788

(52) U.S. Cl. CPC H04N 5/44582; H04N 21/21; H04N 21/4788; H04N 21/472; H04N 21/4122
USPC 725/34

(57) ABSTRACT

An augmented reality object transmission server is provided. The server includes a video content identification unit configured to identify video contents being reproduced in a plurality of devices, a profile determination unit that configured to determine a first profile of a first device and a second profile of a second device, an augmented reality object selection unit configured to select a first augmented reality object from a plurality of augmented reality objects mapped in the video contents based on the determined first profile, and a transmission unit configured to transmit the selected first augmented reality object to the first device. The augmented reality object selection unit may select a second augmented reality object from the plurality of augmented reality objects mapped in the video contents based on the second profile.

### CROSS-REFERENCE TO RELATED APPLICATION

This application claims the benefit of Korean Patent Application No. 10-2013-0034824, filed on Mar. 29, 2013 in the Korean Intellectual Property Office, the entire disclosures of which are incorporated herein by reference.

### BACKGROUND

1. Field

The embodiments described herein pertain generally to a server and a method for transmitting a personalized augmented reality object.

2. Description of Related Art

Services for displaying contents being played through TV devices such as TVs, IPTVs and smart TVs, or smart devices such as smart phones and smart pads, and information associated with the contents together are being created. These services can be provided through content providers connected through networks. This reflects the demands of users who want to identify information associated with contents, in addition to watching the contents.

Meanwhile, the video on demand (VOD) service is generally provided to users through IPTV service providers, and the IPTV service providers may provide users with information associated with contents before the users watch the VOD. In recent, advertisements preferred by users are transmitted, contents preferred by users are recommended, or a variety of information associated with contents is provided based on metadata for objects and advertisements appearing in video contents and user preference information.

However, in order to provide user's preferred information without interrupting user's watching of VOD, new VOD contents should be generated by inserting certain information into frames of VOD contents to encode the information. Since the act of editing VOD contents would be in violation of the copyright law, a method for inserting and providing user's preferred certain information without correcting video contents containing VOD is demanded. With respect to the method for providing a user with certain information, Korean Patent Application Publication No. 2012-0006601 describes a method for synthesizing product meta-information with TV contents in a smart TV environment.

### SUMMARY

In view of the foregoing, example embodiments personalize information and advertisements to be provided through a smart device to conform to user's preference depending on utility of the smart device. Examples embodiments determine profiles of devices by acquiring device information of various devices. However, the problems sought to be solved by the present disclosure are not limited to the above description and other problems can be clearly understood by those skilled in the art from the following description.

In one example embodiment, an augmented reality object transmission server is provided. The server may include a video content identification unit configured to identify video contents being reproduced in a plurality of devices, a profile determination unit that configured to determine a first profile of a first device and a second profile of a second device, an augmented reality object selection unit configured to select a first augmented reality object from a plurality of augmented reality objects mapped in the video contents based on the determined first profile and to select a second augmented reality object from the plurality of augmented reality objects mapped in the video contents based on the second profile, and a transmission unit configured to transmit the selected first augmented reality object to the first device.

In another example embodiment, a method for transmitting an augmented reality object to a device is provided. The method may include identifying video contents being reproduced in a plurality of devices, determining a first profile of a first device and a second profile of a second device, selecting a first augmented reality object from a plurality of augmented reality objects mapped in the video contents based on the determined first profile, and a second augmented reality object from the plurality of augmented reality objects mapped in the video contents based on the determined second profile, and transmitting the selected first augmented reality object to the first device.

In accordance with the above-described example embodiments, it is possible to personalize information and advertisements to be provided through a smart device based on user's preference depending on utility of the smart device. It is possible to provide all augmented reality objects mapped within video contents as personalized information corresponding to user's interests. It is possible to determine profiles of devices through device information of various devices, and augment and provide object information according to utility and environments of devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of an augmented reality object transmission system in accordance with an example embodiment;

FIG. 2 is a configuration view of an augmented reality object transmission server illustrated in FIG. 1 in accordance with an example embodiment;

FIG. 3 shows displaying different augmented reality objects depending on devices in accordance with an example embodiment;

FIG. 4 shows providing personalized augmented reality objects in accordance with another example embodiment;

FIG. 5 shows various types of augmented reality objects in accordance with an example embodiment;

FIG. 6 is a flow chart for providing an augmented reality object in accordance with an example embodiment;

FIG. 7 shows a process, in which data are transmitted among the elements illustrate in FIG. 1, in accordance with an example embodiment; and

FIG. 8 is an operation flow diagram showing a process for transmitting an augmented reality object in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

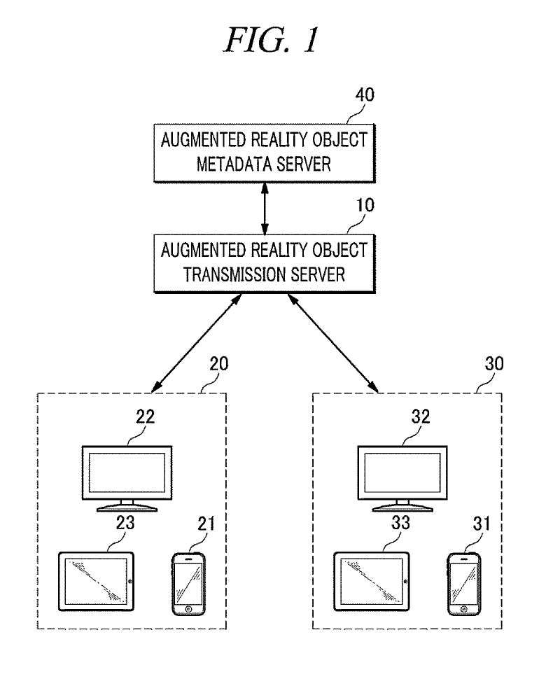

FIG. 1 is a configuration view of an augmented reality object transmission system in accordance with an example embodiment. With reference to FIG. 1, the augmented reality object transmission system includes an augmented reality object metadata server 40, an augmented reality object transmission server 10 and a multiple number of terminals 20 to 30 connected to the augmented reality object transmission server 10 through networks.

The elements of the augmented reality object transmission system of FIG. 1 are generally connected to one another through a network. The network means a connection structure, which enables information exchange between nodes such as terminals and servers. Examples for the network include the 3rd Generation Partnership Project (3GPP) network, the Long Term Evolution (LTE) network, the World Interoperability for Microwave Access (WIMAX) network, the Internet, the Local Area Network (LAN), the Wireless Local Area Network (Wireless LAN), the Wide Area Network (WAN), the Personal Area Network (PAN), the Bluetooth network, the satellite broadcasting network, the analog broadcasting network, the Digital Multimedia Broadcasting (DMB) network and so on but are not limited thereto.

The augmented reality object metadata server 40 may include an augmented reality object, which is augmented information in association with an object appearing in video contents. In this case, the augmented reality object is object information, which can be interacted between an object appearing on video contents and a user. Such an augmented reality object may be in the form of 2D images, 3D images, videos, texts or others, and there may be a multiple number of augmented reality objects for one object. The augmented reality object metadata server 40 may present and store an augmented reality object in a semantic form.

The multiple devices 20 to 30 may be realized as mobile terminals, which can be accessed to a remote server through a network. Here, the mobile devices are mobile communication devices assuring portability and mobility and may include, for example, any types of handheld-based wireless communication devices such as personal communication systems (PCSs), global systems for mobile communication (GSM), personal digital cellulars (PDCs), personal handyphone systems (PHSs), personal digital assistants (PDAs), international mobile telecommunication (IMT)-2000, code division multiple access (CDMA)-2000, W-code division multiple access (W-CDMA), wireless broadband Internet (Wibro) terminals and smart phones, smart pads, tablet PCs and so on. In addition, the multiple devices 20 to 30 may further include TVs, smart TVs, IPTVs and monitor devices connected to PCs and so on.

However, the types of the multiple devices 20 to 30 illustrated in FIG. 1 are merely illustrative for convenience in description, and types and forms of the multiple devices 20 to 30 described in this document are not limited to those illustrated in FIG. 1.

The augmented reality object transmission server 10 can identify video contents being reproduced in the multiple devices 20 to 30. For example, the augmented reality object transmission server 10 may identify video contents being viewed through a smart TV, and even where a smart TV playing video contents is photographed by a camera device connected to a smart phone, the augmented reality object transmission server 10 may identify the corresponding video contents.

The augmented reality object transmission server 10 can determine a first profile of a first device and a second profile of a second device among the multiple devices 20 to 30. For example, the augmented reality object transmission server 10 may determine a profile of a smart phone, which is a first device 21 of a first user among the multiple devices 20 to 30, such as device information of the smart phone, information about the user of the smart phone, and behavior information on use of contents through the smart phone. Alternatively with a profile of a device, tendency of a device, personalized device information and others may be used.

The augmented reality object transmission server 10 can select a first augmented reality object from augmented reality objects matching with the video contents based on the first profile. For example, the augmented reality object transmission server 10 may select at least one augmented reality object to be provided to the smart phone from multiple objects within the video contents based on the determined profile of the smart phone. In other words, the augmented reality object transmission server 10 may select an augmented reality object corresponding to the determined profile from multiple augmented reality objects mapped in the video contents being currently reproduced in the smart phone, based on behavior information of the smart phone, preference of the user of the smart phone or others. In addition, the augmented reality object transmission server 10 can transmit the selected first augmented reality object to the first device.

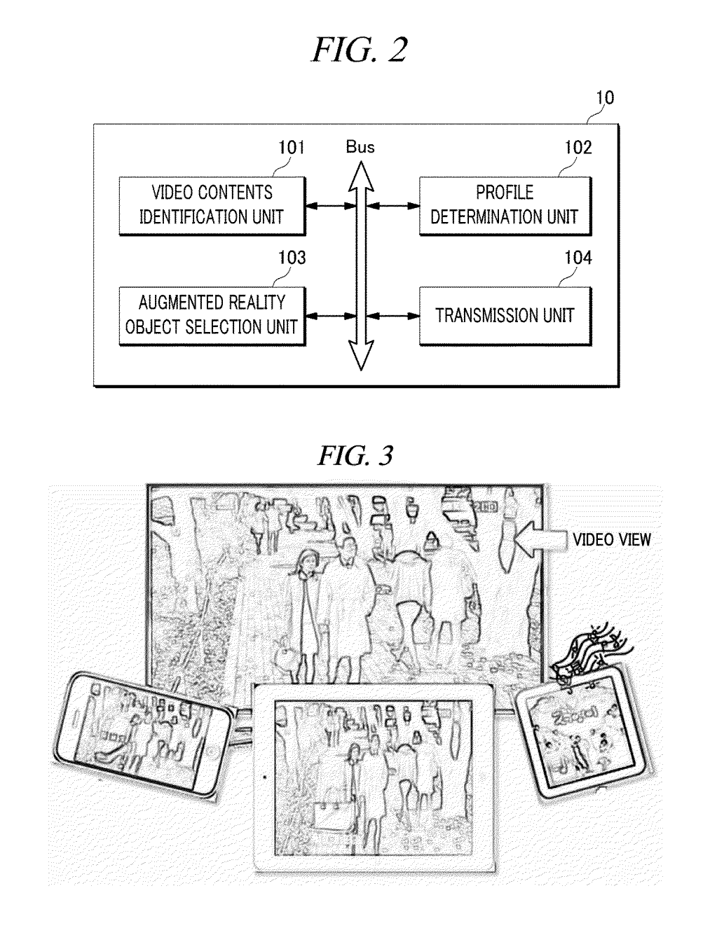

FIG. 2 depicts the above-described operation of the augmented reality object transmission server 10 in detail.

FIG. 2 is a configuration view of the augmented reality object transmission server 10 illustrated in FIG. 1 in accordance with an example embodiment. With reference to FIG. 2, the augmented reality object transmission server 10 includes a video content identification unit 101, a profile determination unit 102, an augmented reality object selection unit 103 and a transmission unit 104. However, the augmented reality object transmission server 10 illustrated in FIG. 2 is merely one example embodiment and may be variously modified based on the elements illustrated in FIG. 2. In other words, in accordance with various example embodiments, the augmented reality object transmission server 10 may have different configuration from that in FIG. 2.

The video content identification unit 101 identifies video contents being reproduced in the multiple devices 20 to 30. For example, where a first user uses multiple smart devices 21 to 23, the video content identification unit 101 may identify home shopping viewed by using a smart phone or a smart TV, or video contents viewed by using a smart pad. For another example, where one user photographs a smart TV by using a camera device connected to a smart phone while viewing video contents by using the smart TV, the video content identification unit 101 may identify the video contents being reproduced in the smart TV photographed through the smart phone. To identify the video contents, metadata of the video contents, which include information of the video contents, may be used.

The profile determination unit 102 determines a first profile of a first device and a second profile of a second device among the multiple devices 20 to 30. In this case, the first profile may be a profile of a user of the first device, or a device profile of the first device. For example, the profile of the user of the first device includes information such as a type of the device possessed by the user, and gender or current location of the user, and may be basic information about the user. Meanwhile, the device profile of the first device may include at least one of details for user's social network service (SNS) activity, details for searches through the Internet, and details for use of video, photo, music or game contents and purchase of contents through the corresponding device. Accordingly, the profile determination unit 102 may determine different profiles for the device 20 of the first user and the device 30 of the second user, and even for the device 20 of the first user, the profile determination unit 102 may determine different profiles.

In another example embodiment, the profile determination unit 102 may determine a profile based on basic information including utilization of a smart device of one user, user's activity information, age, gender and district, and others. To be more specific, where a first user who usually has a lot of interests in furniture has visited web sites providing furniture information by using a smart phone, preferred “A brand” of various brands, and viewed a lot of videos associated with DIY (Do It Yourself) furniture, the profile determination unit 102 may determine a profile associated with the tendency of the corresponding smart phone.

The augmented reality object selection unit 103 selects a first augmented reality object from augmented reality objects mapped in the video contents based on the determined first profile. In this case, the augmented reality object selection unit 103 may select the augmented reality object by calculating similarity between information of a user contained in the profile information of the device and information of the video contents used through the device or augmented reality objects. For example, where one user views video contents through a smart TV, or photographs the smart TV through a camera device connected to a smart phone or pad, the augmented reality object selection unit 103 may select an object preferred by the user from objects appearing in the video contents based on the determined profile. In this case, the augmented reality object selection unit 103 may select different augmented reality objects for the smart TV, the smart phone and the smart pad based on the determined profile.

The augmented reality object selection unit 103 may select an augmented reality object based on an environment of a device. The environment of the device may include network information or performance information of the device. For example, where a user's smart phone provides 3D images, the augmented reality object selection unit 103 may select a 3D type of an augmented reality object, and where a user's smart phone provides full HD, the augmented reality object selection unit 103 may select a high-definition video type of an augmented reality object. Where performance of a device is inferior, the augmented reality object selection unit 103 may exclude 3D and video types of augmented reality objects and select an image or text type of an augmented reality object.

In still another example embodiment, where a user's smart pad is connected to a 3G network, the augmented reality object selection unit 103 may select an image or text type of an augmented reality object in consideration of data usage, and where the corresponding smart pad uses the Wi-Fi network, the augmented reality object selection unit 103 may select a video type of an augmented reality object.

The augmented reality object selection unit 103 can search an augmented reality object based on the determined first profile of the first device through the augmented reality object metadata server 40. The augmented reality object selection unit 103 may search an augmented reality object in at least one of image, 3D, video and text types from the augmented reality object metadata server 40. The augmented reality object selection unit 103 may search at least one augmented reality object mapped in the video contents from multiple types of augmented reality objects stored in the augmented reality object metadata server 40 based on the first profile of the first device and the information of the identified video contents. The augmented reality object selection unit 103 may search an augmented reality object in consideration of network information, performance information and utility of the first device.

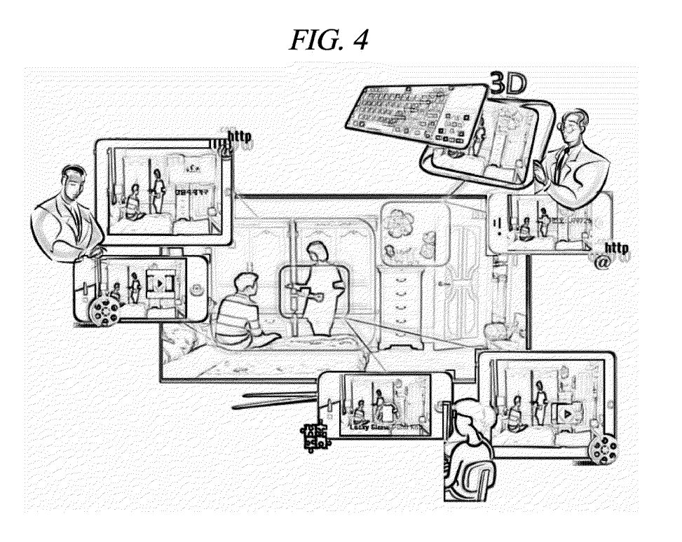

Hereinafter, one example where the augmented reality object selection unit 103 selects an object will be described once more with reference to FIG. 3 and FIG. 4.

FIG. 3 shows displaying different augmented reality objects depending on devices in accordance with an example embodiment, and FIG. 4 shows providing personalized augmented reality objects in accordance with another example embodiment.

With reference to FIG. 3, where identical video contents are used by user's smart TV, smart phone or smart pad, the augmented reality object selection unit 103 may select an augmented reality object regarding shoes appearing in a corresponding scene of the video contents for the smart phone, and an augmented reality object regarding a bag appearing in the same scene for the smart pad, based on determined profiles of the devices and utility of each of the devices.

With reference to FIG. 4, where one user has high preference for furniture, the augmented reality object selection unit 103 may select a web page type of an augmented reality object providing information about the furniture for the smart pad, and a video type of an augmented reality object regarding DIY furniture for the smart phone.

Where another user enjoys conducting 3D works and viewing 3D screens through a smart PC, and surfing the Internet and buying products by using a smart phone, the profile determination unit 102 may determine a profile associated with the preference of the corresponding user, and based on the determined profile, the augmented reality object selection unit 103 may select a 3D type of an augmented reality object regarding antique furniture for the smart PC, and a web-page type of an augmented reality object, which enables prompt buying of products appearing in corresponding video contents, for the smart phone.

In still another example embodiment, where a user usually collects images of women's clothing by using a smart phone, and videos of women's clothing by using a smart pad, the profile determination unit 102 may determine profiles of the smart phone and the smart pad, and the augmented reality object selection unit 103 may select an image or video type of an augmented reality object based on the determined profiles.

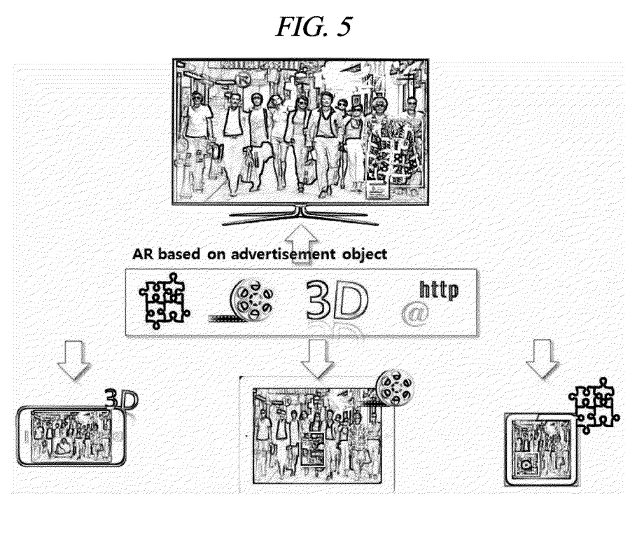

FIG. 5 shows various types of augmented reality objects in accordance with an example embodiment. With reference to FIG. 5, an augmented reality object mapped in video contents may be in one of image, video, 3D and text types. In this case, the augmented reality object may include advertisement information about an object, which can be generated by an advertiser. In addition, the augmented reality object may be mapped for each of multiple objects appearing in a certain frame or scene of video contents, and multiple types of augmented reality objects may be mapped for one object.

The transmission unit 104 transmits the first augmented reality object to the first device. In other words, the transmission unit 104 may transmit first data for the first augmented reality object to the first device based on the type of the first augmented reality object selected by the augmented reality object selection unit 103. For example, the transmission unit 104 may transmit a video type of an augmented reality object associated with DIY furniture to the smart phone, which is the first device 21 of the first user.

The augmented reality object transmitted through the transmission unit 104 may be displayed on a part of the first device, or the augmented reality object and detailed information of the augmented reality object may be briefly displayed. In addition, the augmented reality object and location of the augmented reality object may be displayed on video contents being played in the first device, and the augmented reality object may be displayed directly on video contents. Meanwhile, only the augmented reality object that has been selected by the user can be displayed on the first device, and may be displayed in the manner that the screen of the first device is divided such that the screen of the video contents is not blocked. Besides, the augmented reality object may not appear in a smart TV and may be displayed on a user's smart phone synchronized with the smart TV. However, the method for displaying an augmented reality object on the first device is not limited to those described above.

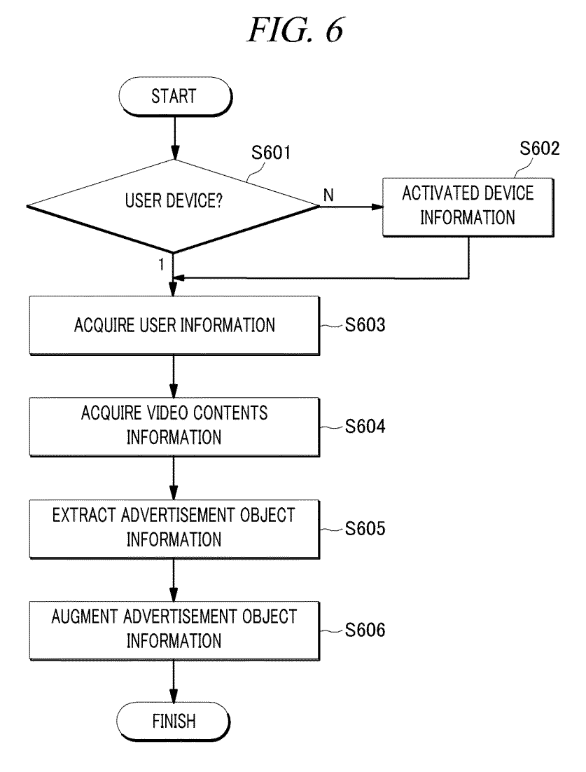

FIG. 6 is a flow chart for providing an augmented reality object in accordance with an example embodiment. With reference to FIG. 6, where a first user photographs a smart TV, which is playing video contents, by using a camera device connected to a smart phone possessed by the first user while viewing the video contents through the smart TV, the augmented reality object transmission server 10 determines the number of devices, which are possessed by the first user and have been registered in the augmented reality object transmission server 10, through the user's own ID (S601). If the device 20 of the first user includes one smart TV as a result of the determination, the augmented reality object transmission server 10 acquires device information of the smart TV, and if the device 20 of the first user includes at least one device, the augmented reality object transmission server 10 acquires device information of the smart phone that is currently photographing the smart TV (S602).

The augmented reality object transmission server 10 acquires information of the user from the device 20 of the first user (S603), and acquires information of the video contents being played in the device 20 of the first user (S604). The augmented reality object transmission server 10 determines a profile of the device 20 of the first user based on the acquired device information and user information, and extracts augmented reality object information from the augmented reality object metadata server 40 based on the determined profile (S605). In addition, the augmented reality object transmission server 10 transmits the extracted augmented reality object information to the user terminal for augmentation (S606).

The metadata for the augmented reality object may include the following properties: ID, which is a property capable of discriminating augmented reality objects; a trajectory type, which indicates a property for information of an augmented reality object and position information of the same; trajectories, which have a relative coordinate value in case of a coordinate and a coefficient value in case of a coefficient depending on the trajectory type property; and a video content size, which indicates values for width and height of an augmented reality object where an augmented reality object is currently being displayed in video contents (Annotation). These properties are summarized in Table 1 below.

TABLE 1

| Data Property | Examples |
|---|---|
| ID | 1, 2, . . . , N |
| Trajectory Type | Position, coefficient |
| Trajectories | x point, y point, 0.569219, 0, −1 . . . |
| Video Content Size | Width, height |

However, the present disclosure is not limited to the example embodiment illustrated in FIG. 6, and there may be other various example embodiments.

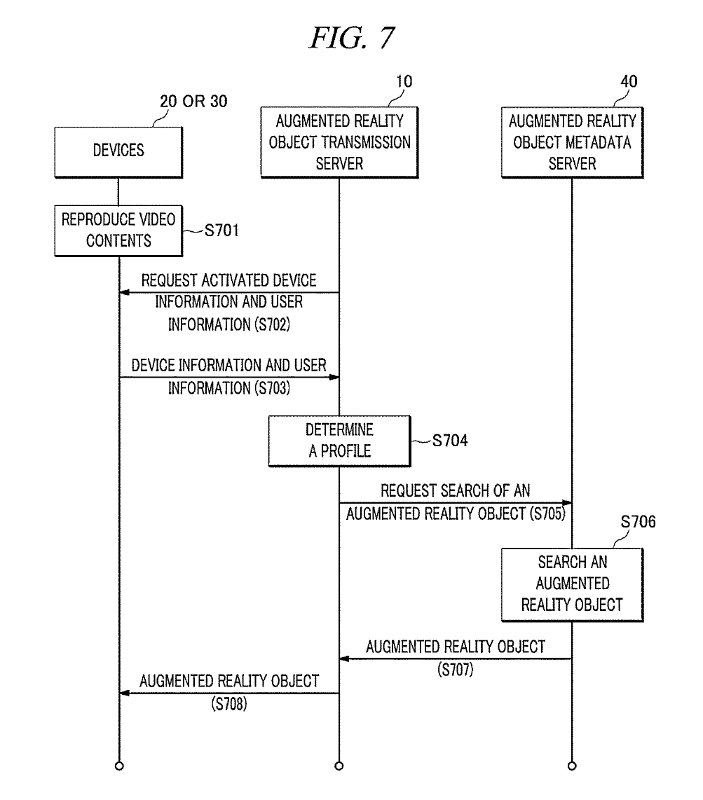

FIG. 7 shows a process, in which data is transmitted among the elements illustrated in FIG. 1, in accordance with an example embodiment. With reference to FIG. 7, any one of the multiple devices 20 to 30 plays video contents (S701). The augmented reality object transmission server 10 requests information of the activated device and user information of the device from the multiple devices 20 to 30 (S702), and acquires the device information and the user information of the device from the activated device (S703). The augmented reality object transmission server 10 determines a profile of each of the devices based on the acquired information (S704), and selects an augmented reality object mapped in the video contents being currently played based on the determined profile. The augmented reality object transmission server 10 requests the augmented reality object metadata server 40 to search the selected augmented reality object (S705), and the augmented reality object metadata server 40 searches the corresponding augmented reality object (S706) to transmit the object to the augmented reality object transmission server 10 (S707). Thereafter, the augmented reality object transmission server 10 transmits the transmitted augmented reality object to any one device corresponding to the profile (S708).

However, the present disclosure is not limited to the example embodiment illustrated in FIG. 7, and there may be other various example embodiments.

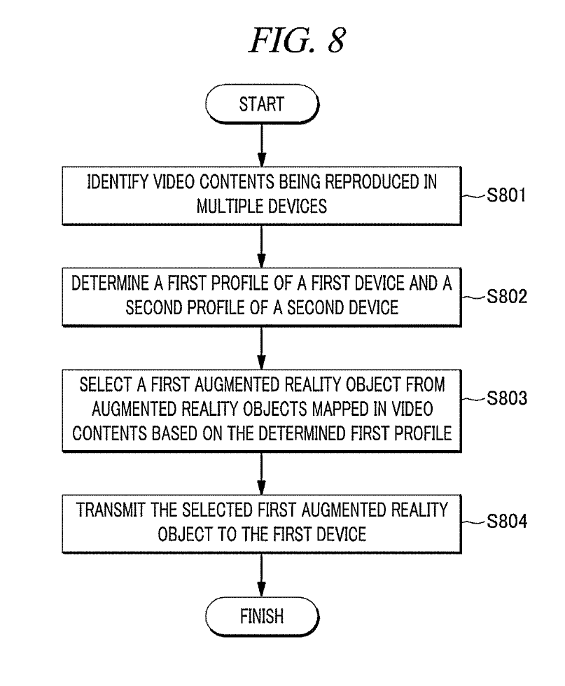

FIG. 8 is an operation flow chart showing a process, in which an augmented reality object is transmitted, in accordance with an example embodiment. The method for transmitting an augmented reality object in accordance with an example embodiment as illustrated in FIG. 11 includes the sequential processes implemented in the augmented reality object transmission server 10 illustrated in FIG. 2. Accordingly, the descriptions of the augmented reality object transmission server 10 with reference to FIG. 1 to FIG. 6 are also applied to FIG. 8 though are not omitted hereinafter.

With reference to FIG. 8, the augmented reality object transmission server 10 identifies video contents being played in the multiple devices 20 to 30 (S801), and determines a first profile of a first device and a second profile of a second device among the multiple devices (S802). In addition, the augmented reality object transmission server 10 selects a first augmented reality object from augmented reality objects mapped in the video contents based on the determined first profile (S803), and transmits the selected first augmented reality object to the first device (S804).

The augmented reality object transmission server 10 may select a second augmented reality object from augmented reality objects mapped in the video contents based on the determined second profile, and transmit the selected augmented reality object to the second device. In this case, the augmented reality object transmission server 10 may select an augmented reality object by calculating similarity between user information contained in the first profile of the first device and information of the video contents used through the device or augmented reality objects.

The augmented reality object transmitting method described with reference to FIG. 8 can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

### EXPLANATION OF CODES

10: Augmented reality object transmission server

20: Device of a first user

30: Device of a second user

40: Augmented reality object metadata server

What is claimed is:

1. An augmented reality object transmission server, the server comprising:
a video content identification unit configured to identify video contents being reproduced in a plurality of devices;
a profile determination unit that configured to determine a first profile of a first device and a second profile of a second device;
an augmented reality object selection unit configured to select a first augmented reality object from a plurality of augmented reality objects mapped in the video contents based on the determined first profile; and
a transmission unit configured to transmit the selected first augmented reality object to the first device,
wherein the augmented reality object selection unit selects a second augmented reality object from the plurality of augmented reality objects mapped in the video contents based on the second profile.

2. The augmented reality object transmission server of claim 1,
wherein the augmented reality object selection unit selects a type of the first augmented reality object based on the first profile, and
the transmission unit transmits first data of the first augmented reality object to the first device based on the selected type.

3. The augmented reality object transmission server of claim 1,
wherein the first profile is a user profile of a first user.

4. The augmented reality object transmission server of claim 1,
wherein the first profile is a device profile of the first device.

5. The augmented reality object transmission server of claim 1,
wherein the augmented reality object selection unit selects the first augmented reality object by calculating similarity between at least two of user information included in the profile information of the first device, information of video contents used through the first device, and first augmented reality object information.

6. The augmented reality object transmission server of claim 3,
wherein the user profile of the first user includes at least one of a type of the device possessed by the first user, or a gender or current location of the first user.

7. The augmented reality object transmission server of claim 4,
wherein the device profile of the first device includes at least one of details for user's social network service (SNS) activity, details for use of video, photo, music or game contents and details for purchase of contents.

8. A method for transmitting an augmented reality object to a device, the method comprising:
identifying video contents being reproduced in a plurality of devices;
determining a first profile of a first device and a second profile of a second device;
selecting a first augmented reality object from a plurality of augmented reality objects mapped in the video contents based on the determined first profile, and a second augmented reality object from the plurality of augmented reality objects mapped in the video contents based on the determined second profile; and
transmitting the selected first augmented reality object to the first device.

9. The method of claim 8,
wherein the first augmented reality object is selected by calculating similarity between at least two of user information included in the profile information of the first device, information of video contents used through the first device, and first augmented reality object information.
